(19) United States
(12) Patent Application Publication
(10) Pub. No.: US 2008/0114901 A1
(43) Pub. Date: May 15, 2008

(54) SERIAL PERIPHERAL INTERFACE (SPI) CONTROL DEVICE, SPI SYSTEM AND METHOD OF DETERMINING A SPI DEVICE

(75) Inventor: Hsiao-Fen Chou, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Taipei (TW)

(21) Appl. No.: 11/782,043

(22) Filed: Jul. 24, 2007

(30) Foreign Application Priority Data
Nov. 13, 2006 (TW) 95141937

(51) Int. Cl. G06F 3/00

(52) U.S. Cl. 710/5

(57) ABSTRACT

A SPI system includes a SPI device and a SPI control device. The SPI control device is for providing a read command of a fast read command format in response to a driving signal outputted by a south-bridge chip. The SPI device stores preset data in a preset address and outputs output data to the SPI control device in response to the read command. The SPI control device is for determining whether the output data is substantially equal to the preset data. When the output data is substantially equal to the preset data, the SPI control device provides a command of the fast read command format to read the SPI device.

This application claims the benefit of Taiwan application Serial No. 095141937, filed Nov. 13, 2006, the subject matter of which is incorporated herein by reference.

### BACKGROUND OF THE INVENTION

1. Field of the Invention

The invention relates in general to a serial peripheral interface (SPI) system, and more particularly to a SPI system which can detect whether a SPI device therein supports a fast read command format.

2. Description of the Related Art

Referring to FIG. 1, a block diagram of a conventional SPI system is shown. A SPI system 100 is applied to a computer system. When the computer system is switched on, a SPI control device 110 receives a read command CMDR generated by a south-bridge chip and writes the read command CMDR into a control register 112. Following that, the control register 112 outputs the read command CMDR via a logic circuit 114 to the SPI device 120 to read the data in the SPI device and output a piece of output data SD. For example, the SPI device 120 is a flash read only memory (Rom), the data of the SPI device 120 is basic input output system (BIOS) codes of the computer system, and the read command CMDR is a command of a read command format. However, the conventional SPI system 100 has a few problems.

Owing that the SPI control device 110 uses a hardware structure of a control register, the SPI control device 110 has to read the data of the SPI device 120 via complicated control steps of the control register 112. As a result, the data reading performance of the SPI system 100 is reduced. In order that the SPI control device 110 can support the fast read command to increase the data reading performance of the SPI device 120, extra registers have to be added into the control register and the BIOS codes of the SPI device 120 have to be re-designed. Therefore, the area of the control register 112 and design difficulty of the BIOS codes will be increased, which in turn increases the cost of the SPI system 100.

Besides, owing that the SPI control device 110 cannot determine whether the companied SPI device 120 supports the fast read command format or not, the conventional SPI control device 110 has to control the SPI device 120 by a read command with higher support ability as the computer system is switched on. After the computer system is switched on, the user adjusts the SPI control device 110 manually such that the SPI control device 110 can control the SPI device 120 by a fast read command instead. Therefore, the SPI system 110 cannot control the SPI device 120 by a fast read command before the computer system finishes turned on and the user's operation steps are much more complicated.

### SUMMARY OF THE INVENTION

The invention is directed to a SPI system and method of determining whether a SPI device supports a fast read command format. The SPI system of the invention has higher reading performance, requires less variation of BIOS codes, can determine whether the SPI device supports the fast read command format and read the SPI device via the fast read command as the computer system is turned on. Besides, the SPI control device can have a smaller area and the user's steps for operating the SPI system can be simplified.

According to a first aspect of the present invention, a SPI control device is provided. The SPI control device is applied to a computer system and the computer system has a south-bridge chip for providing a driving signal for reading a SPI device via the SPI control device. The SPI control device comprises a wire fixing device and a logic circuit. The wire fixing device is for providing a read command in response to the driving signal, wherein the read command has a fast read command format. The logic circuit is coupled to the SPI device for reading the SPI device in response to the read command. The south-bridge chip reads the SPI device via the SPI control device in a memory access direct way.

According to a second aspect of the present invention, a SPI system is provided. The SPI system is applied to a computer system having a south-bridge chip for providing a driving signal. The SPI system comprises a SPI device and a SPI control device. The SPI device is for storing preset data in a preset address and outputting output data in response to a read command. The SPI control device is for providing the read command in response to the driving signal to read the preset data of the SPI device in the preset address, wherein the read command has a fast read command format. The SPI control device is for receiving the output data and determining whether the output data is substantially equal to the preset data, and when the output data is substantially equal to the preset data, it represents the SPI device can support the fast read command format, and the SPI control device provides a command of the fast read command format to read the SPI device.

According to a third aspect of the present invention, a method of determining a SPI device is provided. The method is for determining whether the SPI device supports a fast read command format. The method comprises steps of providing a SPI device, wherein there exists preset data in a preset address of the SPI device; providing a read command to the SPI device, wherein the read command has a fast read command format; outputting output data by the SPI device in response to the read command; determining whether the output data is equal to the preset data; and when the output data is equal to the preset data representing the SPI device supports the fast read command format, providing a command of the fast read command format to the SPI device.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a conventional SPI system.

FIG. 2 is a block diagram of a SPI system according to a preferred embodiment of the invention.

FIG. 3 is a detailed block diagram of the SPI control device of FIG. 2.

FIG. 4 is a detailed circuit diagram of the wire fixing device of FIG. 3.

FIG. 5 is a flow chart of a method of determining whether a SPI device supports the fast read command format.

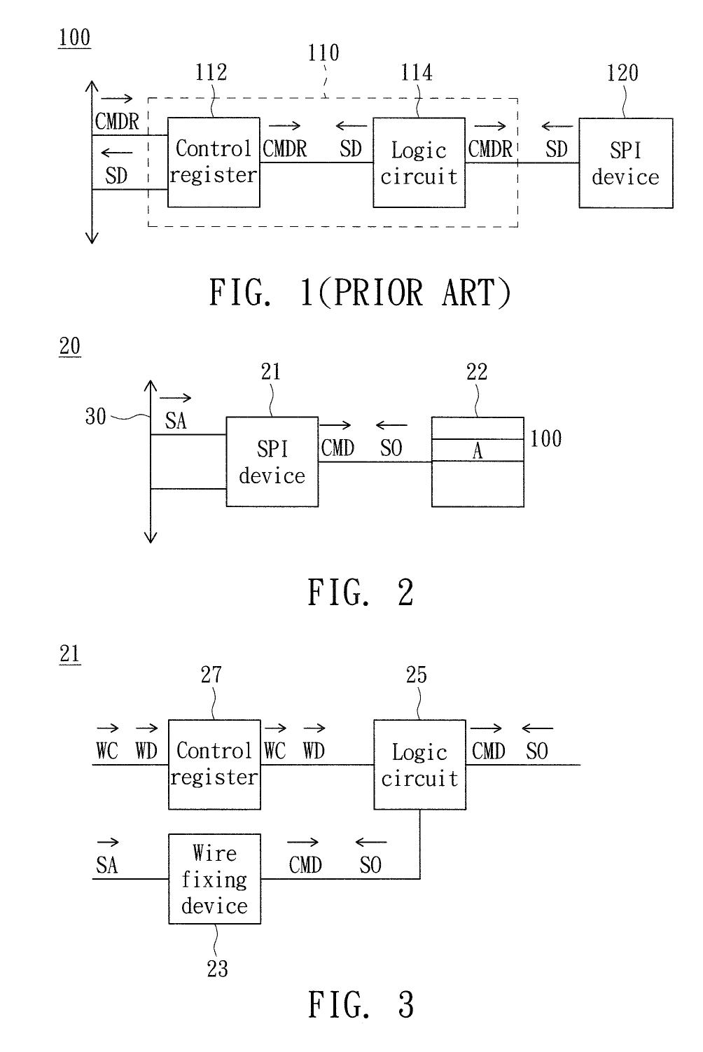

### DETAILED DESCRIPTION OF THE INVENTION

The SPI system of the invention includes a wire fixing device for outputting a command of a fast read command format, determining whether the SPI device supports the fast read command format and reading the SPI device via a hardware path by a memory access direct way.

Referring to FIG. 2, a block diagram of a SPI system according to a preferred embodiment of the invention is shown. A SPI system 20 includes a SPI control device 21 and a SPI device 22. For example, the SPI system 20 is applied in a computer system (not shown in the figure), and the SPI control device 21 is coupled to a south-bridge chip (not shown in the figure) of the computer system via a peripheral component interconnect (PCI) bus 30.

When the computer system is switched on, the computer system provides a driving signal SA to the SPI system 20 via the south-bridge chip so as to read the SPI device 22. The SPI device 22 stores a piece of preset data in a preset address. In the embodiment, the preset address is 100 and the preset data is a capital letter A for instance. The SPI device 22 is for outputting output data SO in response to a read command CMD.

The SPI control device 21 is for providing the read command CMD in response to the driving signal SA to access the data stored in the address 100 of the SPI device 22. The read command CMD has a fast read command format for instance. The SPI control device 21 is further used for receiving the output data SO generated by the SPI device 22 and comparing the output data SO and the preset data A to determine whether the output data SO is substantially equal to the preset data A and determine whether the SPI device 22 can interpret the read command CMD and support the fast read command format.

When the output data SO is substantially equal to A, it represents the SPI device 22 can interpret the read command CMD, that is, can support the fast read command format. Therefore, in the following turn-on and other SPI device reading operations, the SPI control device 21 provides a command of the fast read command format for a reading operation. When the output data SO is not equal to A, it represents the SPI device 22 cannot interpret the read command CMD, that is, cannot support the fast read command format. Therefore, in the following turn-on and other SPI device reading operations, the SPI control device 21 provides a command of a read command format for a reading operation.

Referring to FIG. 3, a detailed block diagram of the SPI control device 21 of FIG. 2 is shown. The SPI control device 21 includes a wire fixing device 23 and a logic circuit 25. The wire fixing device 23 is for providing the read command CMD in response to the driving signal SA and comparing the output data SO with the preset data A to determine if the data SO is substantially equal to A. When the output data SO is not equal to A, the wire fixing device 23 provides the command of the read command format to read the SPI device 22.

The logic circuit 25 is for reading the SPI device 22 in response to the command of the fast read command format or read command format and outputting the obtained data via the SPI control device 21 and the PCI bus 30 to the south-bridge chip.

From the above operation, it can be seen that the SPI system 20 of the embodiment can determine whether the SPI device 22 supports the fast read command format in the turn-on process. Therefore, the SPI system 20 of the embodiment can detect whether the SPI device 22 supports the fast read command format and provides the command of the fast read command format in the turn-on process to read the SPI device 22 in order to improve the reading performance of the SPI system 20.

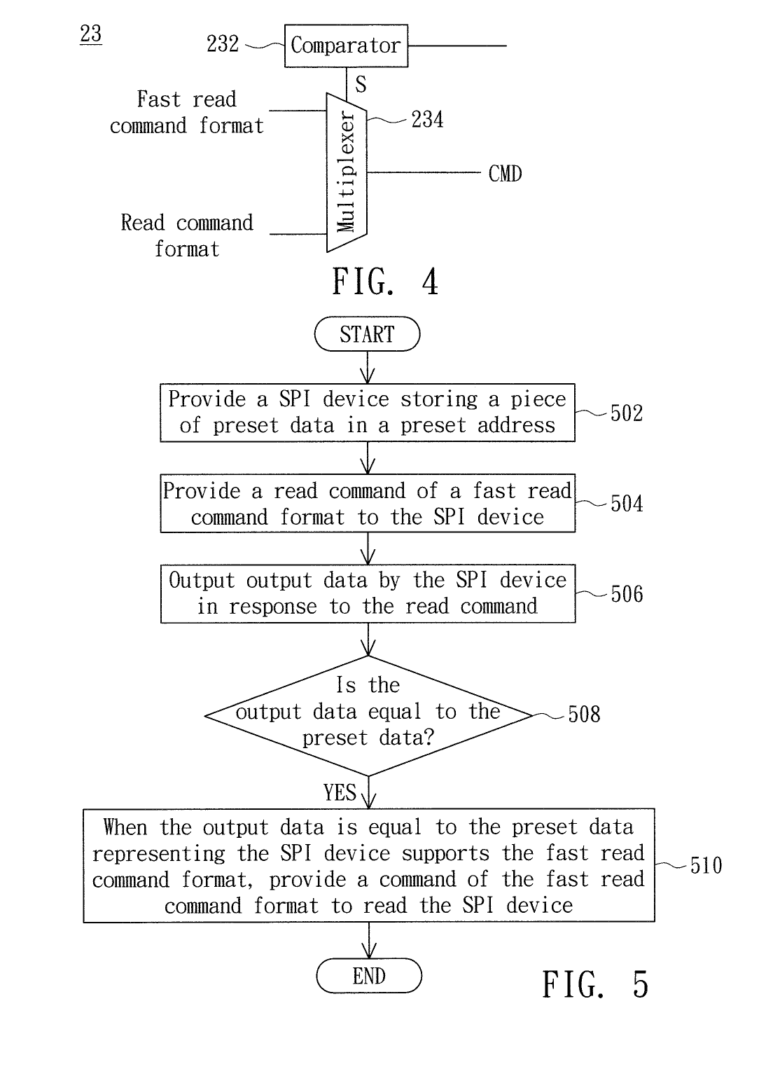

Referring to FIG. 4, a detailed circuit diagram of the wire fixing device 23 of FIG. 3 is shown. The wire fixing device 23 includes a comparator 232 and a multiplexer (MUX) 234. The comparator 232 is used for comparing the output data SO and the preset data A and generating a selection signal S according to a comparison result. When the output data SO is substantially equal to the preset data A, the selection signal S has a first voltage level for instance; when the output data SO is not equal to the preset data A, the selection signal S has a second voltage level for instance.

The multiplexer 234 is for outputting the command of the read command format or fast read command format in response to the selection signal S to the SPI device 22 via the logic circuit 25. For example, the multiplexer 234 generates the command of the fast read command format in response to the first voltage level of the selection signal S and generates the command of the read command format in response to the second voltage level of the selection signal S.

From the above operation, it can be seen that in the reading operation of the SPI control device 21 of the embodiment, the SPI control device 21 provides the read command CMD by the wire fixing device 23 in response to the driving signal SA in stead of providing the read command to control the SPI device 120 via the control register 112 of the conventional SPI control device 110. Therefore, in the embodiment, the south-bridge chip can read the SPI device 22 via the wire fixing device 23 in a memory access direct way. The SPI system 20 of the embodiment can read the SPI device 120 in the memory access direct way, which simplifies the complicated steps and flows of the conventional south-bridge chip for setting the control register 112 and improves the data reading performance of the SPI system 20.

Referring to FIG. 5, a flow chart of a method of determining whether a SPI device supports the fast read command format is shown. First, in step 502, provide the SPI device 22, wherein a piece of preset data is stored in a preset address of the SPI device 22. In the embodiment, the preset address is 100 and the preset data is A for instance. Following that, in step 504, provide the read command CMD to the SPI device 22 to read the data stored in the address 100. The read command CMD is a command of the fast read command format for instance.

Afterwards, in step 506, the SPI device 22 outputs the output data SO in response to the fast read command. Then, in step 508, the wire fixing device 23 determines whether the output data SO is substantially equal to preset data A and the SPI device supports the fast read command format. Next, in step 510, when the output data SO is substantially equal to preset data A, it represents the SPI device 22 supports the fast read command format. Therefore, in the following reading operation, the wire fixing device 23 provides the command of the fast read command format for reading the SPI device 22.

After the step 508, the method further includes a step 512. In the step 512, when the output data SO is not equal to preset data A, it represents the SPI device 22 does not support the fast read command format. Therefore, in the following reading operation, the wire fixing device 23 provides the command of the read command format for reading the SPI device 22.

For example, the SPI device 22 is a SPI flash Rom for storing the BIOS data of the computer system. When the computer system is turned on, the south-bridge chip reads BIOS codes in the SPI flash Rom via the SPI control device 21 in order to perform a turn-on operation of the computer system.

The SPI control device 21 further includes a control register 27 for receiving a write command WC and write data WD provided by the south-bridge chip through the PCI bus 30. The control register 27 is for writing the write command WC and write data WD into the corresponding command register and data register of the control register 27. Afterward, the control register 27 performs a data writing operation on the flash Rom according to the command and information respectively stored in the command and data registers.

A wire fixing device is disposed in the SPI control device of the SPI system of the embodiment for outputting a command of a fast read command format to read specific data stored in a specific address of the SPI device of the SPI system and determining whether the SPI device supports the fast read command format according to the data read. Therefore, the SPI system of the embodiment can effectively improve the drawbacks of the conventional SPI system not capable of detecting whether the SPI device can support the fast read command format and controlling and reading the SPI device by a command of the fast read command format before the computer system finishes turned on. In practical applications, the SPI system of the invention can detect whether the SPI device supports the fast read command format and directly provide the command of the fast read command format to read the SPI device as the computer system is turned on.

Besides, the SPI system of the embodiment can read the SPI device by a hardware path in a memory access direct way. Therefore, the SPI system of the embodiment can effectively improve the drawback of the conventional SPI system reading the SPI device via a hardware structure of a control register and thus reducing the data reading performance and have the advantage of improving the data reading performance.

Furthermore, the SPI system of the embodiment uses a wire fixing device for a hardware structure and can support the fast read command and read command formats. Therefore, the SPI control device of the embodiment can effectively improve the drawback of the conventional SPI control device which requires more registers for supporting the fast read command format, resulting area and cost increase and special design of the BIOS codes. Substantially, the SPI system of the invention can have a smaller area and lower cost without needing special design of the BIOS codes.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A serial peripheral interface (SPI) control device, applied to a computer system, the computer system having a south-bridge chip for providing a driving signal for reading a SPI device via the SPI control device, the SPI control device comprising:
a wire fixing device, for providing a read command in response to the driving signal, wherein the read command has a fast read command format; and
a logic circuit, coupled to the SPI device for reading the SPI device in response to the read command;
wherein the south-bridge chip reads the SPI device via the SPI control device in a memory access direct way.

2. The SPI control device according to claim 1, wherein the SPI device stores preset data in a preset address and the SPI device outputs output data in response to the read command.

3. The SPI control device according to claim 2, wherein the wire fixing device is used for providing the read command to the SPI device in response to the driving signal;
wherein the wire fixing device is further used for receiving the output data and determining whether the output data is substantially equal to the preset data, when the output data is substantially equal to the preset data, it represents the SPI device can support the fast read command format, the wire fixing device provides a command of the fast reading command format and the logic circuit reads the SPI device in response to the command of the fast reading command format provided by the wire fixing device.

4. The SPI control device according to claim 2, wherein when the output data is not equal to the preset data, it represents the SPI device does not support the fast read command format, the wire fixing device provides a command of a read command format and the logic circuit reads the SPI device in response to the command of the read command format.

5. The SPI control device according to claim 2, wherein the wire fixing device comprises:
a comparator, for comparing the output data and the preset data, and generating a selection signal according to a comparison result; and
a multiplexer, for outputting the command of a read command format or the command of the fast read command format to the logic circuit in response to the selection signal so as to read the SPI device via the logic circuit.

6. The SPI control device according to claim 2, further comprising:
a control register, for receiving a write command provided by the south-bridge chip and accordingly performing a data writing operation on the SPI device.

7. A SPI system, applied to a computer system, the computer system having a south-bridge chip for providing a driving signal, the SPI system comprising:
a SPI device, for storing preset data in a preset address and outputting output data in response to a read command; and
a SPI control device, for providing the read command in response to the driving signal to read the preset data of the SPI device in the preset address, wherein the read command has a fast read command format;
wherein the SPI control device is for receiving the output data and determining whether the output data is substantially equal to the preset data, when the output data is substantially equal to the preset data, it represents the SPI device can support the fast read command format, and the SPI control device provides a command of the fast read command format to read the SPI device.

8. The SPI system according to claim 7, wherein the SPI control device comprises:
a wire fixing device, for providing the read command in response to the driving signal, and comparing the output data and the preset data, wherein when the output data and the preset data are substantially equal, the wire fixing device provides the fast read command format; and
a logic circuit, for reading the SPI device in response to the fast read command provided by the wire fixing device;
wherein the south-bridge chip reads the SPI device via the wire fixing device in a memory access direct way.

9. The SPI system according to claim 8, wherein when the output data and the preset data are not equal, the wire fixing device provides a command of a read command format, and the logic circuit reads the SPI device in response to the command of the read command format.

10. The SPI system according to claim 9, wherein the wire fixing device comprises:
a comparator, for comparing the output data and the preset data, and generating a selection signal according to a comparison result; and
a multiplexer, for outputting the command of the read command format or the command of the fast read command format to the logic circuit in response to the selection signal so as to read the SPI device via the logic circuit.

11. The SPI system according to claim 7, wherein the SPI control device further comprises:
a control register, for receiving a write command provided by the south-bridge chip and accordingly performing a data writing operation on the SPI device.

12. A method of determining a SPI device, for determining whether the SPI device supports a fast read command format, the method comprising steps of:
providing the SPI device having a preset data in a preset address of the SPI device;
providing a read command to the SPI device, wherein the read command has a fast read command format;
outputting output data by the SPI device in response to the read command;
determining whether the output data is equal to the preset data; and
when the output data is equal to the preset data representing the SPI device supports the fast read command format, providing a command of the fast read command format to the SPI device.

13. The method according to claim 12, reading the SPI device in a memory access direct way.

14. The method according to claim 12, wherein after the step of determining whether the output data is equal to the preset data, the method further comprises:
when the output data is not equal to the preset data representing the SPI device does not support the fast read command format, providing a command of a read command format to the SPI device.
